(19) United States
(12) Patent Application Publication
(10) Pub. No.: US 2006/0118527 A1
(43) Pub. Date: Jun. 8, 2006

(54) Method and device for short-cycle arc welding

(76) Inventors: Klaus Gisbert Schmitt, Giessen (DE); Joachim Schneider, Ehringshausen (DE)

Correspondence Address: HARNESS, DICKEY & PIERCE, P.L.C., P.O. BOX 828, BLOOMFIELD HILLS, MI, 48303, US

(21) Appl. No.: 11/274,762

(22) Filed: Nov. 15, 2005

(30) Foreign Application Priority Data
Nov. 16, 2004 (DE) 10 2004 056 021.8

(51) Int. Cl. B23K 9/20

(52) U.S. Cl. 219/99

(57) ABSTRACT

The invention relates to a method for short-cycle arc welding with drawn-arc ignition, wherein a stud is welded to a piece of sheet metal, with the following steps: provision of a stud having an end face with which the stud is welded to a welding surface of the sheet metal, wherein an integral distinct projection is formed in the end face, placement of the projection on the welding surface and switch-on of an electric pilot current, lifting of the stud from the welding surface, whereby an arc is drawn, establishment of a welding current flowing through the arc in such a manner that the end face and the welding face start to melt, lowering of the welding stud onto the welding surface, wherein the melts at the end face and welding surface mix, and switch-off of the welding current so that the entire melt solidifies to join the stud to the sheet metal in a material-to-material manner, wherein after lifting of the welding stud and before establishment of the welding current, an alternating cleaning current is initially established in a cleaning step that is designed to clean the welding surface and/or the end face of contaminants, such as lubricants or wax, and/or of coatings, for example corrosion-protective coatings of zinc.

### CROSS REFERENCE TO RELATED APPLICATIONS

This application claims priority to German Application No. 10 2004 056 021.8, filed Nov. 16, 2004, which is incorporated by reference herein.

### BACKGROUND OF THE INVENTION

The invention relates to a method for short-cycle arc welding with drawn-arc ignition, wherein a stud is welded to a workpiece, in particular to a piece of sheet metal. This method is also known as stud welding.

In stud welding, a distinction is drawn between methods with drawn-arc ignition and methods with tip ignition. In stud welding with drawn-arc ignition, a stud is placed on the workpiece and a pilot current is switched on. Then the stud is lifted from the workpiece, drawing an arc. In tip ignition methods, the stud is generally held at a distance from the workpiece, moved to the workpiece by spring force, and immediately upon contact between the stud and workpiece, the arc is ignited by a high voltage (generally a capacitor discharge).

Stud welding with drawn-arc ignition has gained general acceptance in the automotive field. A primary reason for this is that stud welding with tip ignition is relatively noisy as a result of the abrupt arc ignition. Moreover, stud welding with tip ignition does not permit satisfactory weld quality on uncleaned auto body components. In this context, uncleaned means, for example, that the body component has not been cleaned of lubricants from a previous deep-drawing process. The welding of metallic studs to sheet steel has been known in the automotive field for many years. In recent years, aluminum has gained in importance as a material and is widely used in car body manufacture. Thus, appropriate methods for welding aluminum studs to sheet aluminum have also been developed.

The term “stud” is to be understood in a broad sense in the present context. In this regard, it can include threaded studs, unthreaded studs, flanged studs, T studs, tapped studs, etc. In the present instance, however, the term “stud” also includes other workpieces that are welded onto sheet metal using the stud welding method, such as nuts, etc. Stud welding with drawn-arc ignition is described in guideline DVS0902 of the Deutscher Verband für Schweiβtechnik e.V. [German welding association]. The tip-ignition method is described in guideline DVS0903. Various stud types are described in European Standard prEN ISO 13918.

In the tip ignition method, a so-called ignition tip is provided on the end face of the stud facing the workpiece. The ignition tip helps ignite the arc. During the process, a very rapidly rising capacitor discharge current (˜10 kA/ms) passes through the ignition tip. This high current causes an explosive vaporization of the ignition tip, similar to that which occurs in an electrical fuse, thus igniting the arc. In order to ensure that the arc's ignition time and burn time are always reproducible, very stringent requirements for dimensional accuracy are placed on the diameter and length of the ignition tip (generally ±0.05 mm and ±0.08 mm, respectively).

In stud welding with drawn-arc ignition, the end face of the stud that faces the workpiece is generally flat or slightly conical. The arc is ignited in a short-circuited welding circuit with a pilot current of, for example, 20 A by the controlled lifting of the stud from the workpiece. The initiation of the arc is thus quiet and absolutely reproducible. For this reason, this method generally does not require an ignition tip on the stud.

With steel studs of relatively large diameter (>10 mm), however, a stamped-in aluminum sphere or sprayed aluminum coating can be provided at the stud tip (when a conical end face is used). The aluminum serves as a flux in this case (see also the aforementioned standard prEN ISO 13918). Moreover, this aluminum additive to the steel stud makes it easier to ignite the arc and serves to deoxidize the weld pool (bind up the oxygen), as explained in the aforementioned guideline DVS0902 (dated July 1988).

A stud for stud welding with tip ignition is described in the document DE 196 22 958 C1. There, the end face of the stud is conically domed inwards. The ignition tip there must be made significantly longer. The goal of this measure is to minimize the blow effect that occurs. As a result of the high driving voltage and the magnitude of the welding current present (approximately 10 kA), the capacitor discharge welding used there provides the arc with adequate opportunity to escape to where the least exit work for electrons is needed. This expresses itself in an intense blow effect if the surface conditions are not uniform.

In addition, there is known from DE-OS 2,227,384 a welding stud for the tip ignition method that has an ignition tip which is provided on symmetrically and radially arranged star-shaped projections which flatten toward the edge of the end face. In this context, a variation of the tip ignition method is disclosed wherein the contact tip is pressed against the workpiece when the arc is ignited. The contact tip here also serves as a type of spacer, since the space between the stud and the workpiece is not increased after ignition of the arc and vaporization of the contact tip. Instead, the partially molten stud is plunged into the partially molten workpiece starting from this “contact tip height.”

An additional tip ignition method is known from DE-OS 2,739,867, wherein a first conductive part is fastened to a second conductive part. The document DE 8,017,920 U1 also discloses a stud with a cylindrical ignition tip for stud welding with tip ignition. The basic idea here is that the ignition tip can be applied to both end faces of the stud and that these end faces are flat in design instead of conical.

DE 9,320,710 U1 discloses a device for stud welding with drawn-arc ignition wherein the welding stud is nail-shaped. The needle point represents the joint zone of the stud. It transitions without a flange directly into a long stud shank that is electrically insulated with respect to the outside and terminates in a disproportionately large nail head. This head is disk-shaped and can be electrically insulated on the side facing the stud shank. These studs are used to fasten damping or thermal insulation mats to thin sheet metal components.

The utility model specification DE 8,220,820 U1 describes a so-called headed stud which is butt welded in reinforced concrete composite structures using stud welding with drawn-arc ignition with long welding times of >1 second. The shank end of the headed stud has a blunt, conical point with an ignition tip of a conventional material that facilitates arc initiation and can be pressed into the tip to secure it. To this extent, this utility model specification also refers to the guideline DVS0902, and thus likewise discloses pressing an aluminum ball into a steel stud, specifically with the advantage that the aluminum ball has a deoxidizing effect on the molten steel material.

The published application DE 199 22 679 A1 describes a two-stage method for short-cycle arc welding in which a stud with an ignition tip is used. In the first stage, the process proceeds as in the manner of stud welding with tip ignition, but not with the goal of welding the stud in place. Instead, this step is intended to clean the surfaces of the affected components in the joint zone of deep drawing agents and to vaporize the surface coatings. In the process, the surface of the components is partially melted to a slight degree. The actual welding process then takes place approximately 1 second later in the second stage of the process, which is carried out in the manner of short-cycle arc welding with drawn-arc ignition. Here, too, the significant noise produced in the first process step is a disadvantage.

Known from DE 195 24 490 A1 is an additional multi-stage method for welding studs to a workpiece. This method uses ordinary welding studs, however. Another drawn arc ignition welding method with a cleaning stage is known from DE 199 25 628 A1, wherein magnetic arc deflection is used to influence the arc and its shape in such a way that a coating on an aluminum surface is removed from the place where welding with the stud is to later occur. Another method for welding elements to a workpiece is disclosed in DE 199 27 371 C2, which discloses a method with drawn-arc ignition and a method with tip ignition. This document additionally discloses a number of studs with variously designed end faces, but without indicating in detail which type of stud is especially useful for which method.

### BRIEF SUMMARY OF THE INVENTION

In view of the above background, the object of the present invention is to specify a method for stud welding that is capable of welding steel studs to sheet steel, and also, in particular, aluminum studs to sheet aluminum, while also making it possible to carry out an efficient cleaning of the joint faces if applicable. It is a further object of the invention to specify a stud for such a method, a method for producing such a stud, and also the use of such a stud for a stud welding process. This object is attained by a method for short-cycle arc welding with drawn-arc ignition, wherein a stud is welded to a workpiece, more particularly to a piece of sheet metal, with the following steps:

a) provision of a stud having an end face with which the stud is welded to a welding surface of the workpiece, wherein a distinct projection is formed in the center of the end face,

b) placement of the projection on the welding surface and switch-on of an electric pilot current,

c) lifting of the stud from the welding surface, whereby an arc is drawn,

d) establishment of a welding current flowing through the arc in such a manner that the end face and the welding face start to melt,

e) lowering of the welding stud onto the welding surface, wherein the melts at the end face and welding surface mix, and

f) switch-off of the welding current so that the entire melt solidifies to join the stud to the workpiece in an integral manner.

The above object is further attained by a stud for short-cycle arc welding with drawn-arc ignition in which the stud is welded to a workpiece, more particularly to a piece of sheet metal, wherein the stud has an end face with which said stud is welded to a welding surface of the workpiece, wherein a distinct projection is formed in the center of the end face and wherein the projection is designed as a single piece (unitary) with the stud. Additionally, the above object is attained by a method for producing such a stud wherein the projection is formed as an integral part of the stud and wherein the tolerances for the dimensions of the projection are greater than ±0.1 mm. Finally, the above object is attained by the use of such a stud for short-cycle arc welding with drawn-arc ignition in accordance with the invention.

In the inventive method, to put it simply, stud welding with drawn-arc ignition is used in combination with a stud that has a distinct projection in the manner of a contact tip. This method achieves a decisive advantage in the generation of the arc, especially when the end face and/or welding surface are to be cleaned in the process. The inventive method is thus especially suitable for use in the automotive industry. The drawn arc ignition stud according to the invention differs from conventional drawn arc ignition studs in its distinct, integral projection. This projection is thus not a pressed-in aggregation of a different material to improve oxidation characteristics.

In the manufacturing method according to the invention, it is of particular advantage that the tolerances can be very modest. The distinct projection on the stud is formed as an integral part and the tolerances for it are relatively large, especially in comparison to the tolerances that are necessary for tip ignition studs to achieve precise and reproducible arc ignition. Moreover, the use according to the invention is especially important, since the advantages of using a contact point or projection on a drawn arc ignition stud have never before been recognized, despite the fact that a similar projection is present on tip ignition studs. The actual welding step d) can be performed here with direct current or alternating current, depending on the application. The object is thus attained in full.

It is especially advantageous when, after lifting of the welding stud and before establishment of the welding current, a cleaning current is initially established in a cleaning step that is designed to clean the welding surface and/or the end face of contaminants and/or coatings such as lubricants, wax, zinc, or the like. In performing a cleaning step as part of a stud welding process with drawn-arc ignition according to the present invention, it is of particular advantage that, as a result of the distinct projection, the arc used in the cleaning step is produced significantly more concentrically to the joint axis as compared to cases in which the stud has a flat or typically slightly conical end face.

Moreover, the use of a coil to magnetically influence the arc is not necessary. Consequently, the welding head can be made much slimmer. Additional interfering edges are avoided and the accessibility of the welding tools is not impaired. On the whole, a significant contribution is made to the prevention of arc blow from non-magnetic causes.

The provision of the distinct projection makes it possible to move the lubricant from the immediate vicinity of the end face into the vicinity of the distinct projection during manufacturing of welding studs by cold-forming. Unlike the case of studs with ignition tips, the lubricant here has no adverse effect on the geometry of the contact tip. As a result, this does not increase the cost of stud manufacture, and also makes for clean and adequate formation of the end face of the welding stud. In conventional studs, minimal amounts of oil that are needed for lubrication in the cold-forming process during stud manufacture collect in the end face region of the cold-forming tool and thus result in forming of the stud end face that tends to be more domed than conical. This can cause the arc to be ignited and sustained off-center from the stud axis, and thus cause a blow effect on the arc that is not magnetic in origin.

During the cleaning step of the inventive method, the projection on the end face in general is melted completely, even if the cleaning current is significantly smaller than the welding current. This achieves the result that the projection does not leave an imprint on the back of the workpiece after the actual welding step. In general, the cleaning current can be smaller than, equal to, or greater than the welding current. On account of the distinct projection, the arc during the cleaning step is always produced at the center of the stud's end face, ensuring that the end face and the associated welding face on the workpiece, rather than adjacent areas, are cleaned. In this way, it is possible overall to avoid situations where the cleaning arc becomes asymmetrical and causes adverse welding results, especially results where the bending strength in one direction is sharply reduced due to blow effects.

The method according to the invention with a cleaning step is especially suitable for use in the automotive industry, where it is generally the case that studs must be welded onto workpiece surfaces that have not been cleaned. Moreover, the cleaning step is especially important for stud welding with aluminum components. Today in the automotive industry, aluminum components are cleaned of the residues from the preceding deep drawing steps prior to processing in the body-in-white. This takes place in a washing process, which in general is a combined pickling and passivation process. The goal of the washing process is to provide suitable and consistent boundary conditions for certain subsequent processes. Included among these processes is short-cycle drawn arc stud welding. The washing process is very cost-intensive. For this reason, efforts are being made to move this washing process forward to the sheet aluminum manufacture, where the metal sheets are automatically surface treated and wetted with dry lubricants or wax in a very thin and even layer (<1 μm thickness) “on the production line”. These dry lubricants have no adverse effects on most processes used after cold forming in car body manufacture. For short-cycle arc welding according to the prior art, this pretreatment ultimately results in a reduction in joint quality that is discernable in the form of increased porosity.

In order to clean the surfaces of workpieces and studs of undesirable wetting agents and coatings, the cleaning step is performed. This step, in conjunction with providing the stud with a distinct projection, has the result that concentric cleaning around the joint zone is always achieved, which was not always possible in the prior art. It is noteworthy here that all this can take place without high-frequency voltages (voltage peaks at capacitor discharge) or high voltages. In general, the welding currents in the inventive stud welding with drawn-arc ignition are in the range of <2000 amps. Moreover, the rather domed formation of the nominally conical end face—which was a possible contributing cause of uneven arc formation in the cleaning step—is avoided.

According to an especially preferred embodiment, the cleaning step is performed once the arc voltage at the pilot current has exceeded a first predetermined threshold value. In simplified terms, the greater or thicker the contaminants or coatings, which generally are electrically insulating, the greater the arc voltage is. The reason for this is that, for a given welding current, the voltage is proportional to the electrical resistance. Consequently, if the thickness of the contaminants/coatings exceeds a certain threshold value, the cleaning step is performed. If, in contrast, no contaminants are present, which is manifested in a low arc voltage, it is possible to skip the cleaning step. According to another preferred embodiment, the cleaning step is terminated when the arc voltage at the selected cleaning current drops below a second predetermined threshold value. This has the advantage that the cleaning step only has to be performed for the length of time that is actually necessary. Alternatively, however, it is also possible to perform the cleaning step within a fixed period of time, wherein the fixed time period preferably can be selected in advance.

It is further preferred for the cleaning current to be selected as an alternating current. In this context, an alternating current of low frequency (<200 Hz) is chosen so that no high frequency interference is generated. However, the alternating polarity of the cleaning current has the advantage that the cleaning effect is directed equally to both surfaces to be cleaned (end face and welding surface). It has been determined that the cleaning step acts to a greater extent on the end face or on the welding surface depending on polarity. As a result of the alternating current, both surfaces are optimally cleaned. It is of particular advantage in this context if the polarity of the cleaning current is reversed in the range from two to ten times during the cleaning step. This is easy to implement with regard to control technology, and on the whole produces very good cleaning results.

According to another preferred embodiment, the duty cycle during the cleaning step is adjusted as a function of the degree to which the end face and the welding surface are to be cleaned. In the event that it is found in an application that, for example, the welding surface generally needs more cleaning than the end face, the duty cycle can be set such that the cleaning current remains longer in the polarity at which it is more effective for the surface requiring more cleaning. According to another embodiment, the symmetry of the alternating current is set with respect to the zero line during the cleaning step as a function of the degree to which the end face and the welding surface are to be cleaned. In this way, an effect similar to the previous embodiment can be achieved, specifically an emphasis on the cleaning of one of the surfaces. It is a matter of course that the two measures may also be combined with one another.

As already mentioned above, it is especially advantageous for the workpiece and the stud to be made of an aluminum alloy. The advantages of the invention are especially evident in stud welding with aluminum, in particular. It is also possible to use especially thin workpieces without the risk of poor welding results. The method according to the invention can also be used advantageously when the workpiece and the stud are made of steel, however.

With respect to the stud according to the invention, it is especially advantageous for the projection to project beyond the end face by 0.1 to 1 mm, more particularly by 0.3 to 0.6 mm. This dimension is advantageous in that it is possible to ensure, with the cleaning currents typically used, that the projection melts completely during the cleaning step and/or the welding step. To this end, it is further preferred for the projection to have a diameter of 0.1 to 2 mm, more particularly in the range from 0.3 to 1.2 mm. It is also advantageous in this regard for the projection to taper toward its free end. This facilitates a still stronger concentration on the center of the stud axis when the arc is ignited. It is advantageous in this regard for the projection to have a diameter in the region of the end face in the range from 0.1 to 2 mm, more particularly from 0.3 to 1.5 mm, and especially preferred from 0.8 to 1.2 mm. It is also advantageous in this regard for the projection to have a diameter in the region of its free end in the range from 0.1 to 2 mm, more particularly from 0.2 to 1.2 mm, especially preferred from 0.3 to 0.6 mm. Of course, the features mentioned above and those to be explained below need not be used only in the specific combinations given, but may also be used in other combinations or alone without departing from the scope of the present invention.

### BRIEF DESCRIPTION OF THE SEVERAL VIEWS OF THE DRAWINGS

Example embodiments of the invention are shown in the drawings and are explained in detail in the description below. The drawing shown in:

FIG. 1 is a schematic view of a stud welding system for carrying out the method according to the invention;

FIG. 2 is a schematic side view of a stud according to the invention for use in the welding process according to the invention;

FIG. 3 is a flow diagram of an embodiment of the method according to the invention;

FIG. 4 is a diagram of arc current, arc voltage and stud travel over time to illustrate a preferred embodiment of the welding method in accordance with the invention;

FIG. 5 is a representation comparable to FIG. 4, but with a cleaning step omitted;

FIG. 6 is a representation comparable to FIG. 4 of stud travel and welding current over time, wherein an alternating current is applied during the cleaning step;

FIG. 7 is the representation of the end faces of aluminum studs cleaned by the method according to the invention; and

FIG. 8 is a representation comparable to FIG. 7 of aluminum studs that were produced and cleaned according to prior art.

### DETAILED DESCRIPTION OF THE INVENTION

In FIG. 1, a stud welding system for carrying out the stud welding method according to the invention is labeled 10 as a whole. The stud welding system 10 has a welding head 12 of a design that is known per se, which is carried by a carriage 14 on a robot (articulated robot) 16. A direction of travel of the welding head 12 on the carriage 14 is labeled 18. The direction of travel 18 extends perpendicular to the surface of a workpiece 20 having the form of a sheet of aluminum to which an aluminum stud is to be welded.

A control/supply unit 22 is connected to the workpiece 20 and the welding head 12. The control/supply unit 22 has a power supply 24 (for example, a switching power supply) that is capable of delivering welding currents of up to 2000 amps either in a DC mode or, in an alternative embodiment, as AC current as well. The power supply 24 is connected by a first line 25a to the welding head 12 and to a stud not shown in detail in FIG. 1, which is held on the welding head 12. A second line 25b of the power supply (for example, a ground line in the case of direct current) is connected to the workpiece 20.

Studs are supplied automatically to the welding head 12 through a line 26. In addition, the control/supply unit 22 additionally supplies inert gas through an inert gas line 28. A measurement line 30 is provided to measure electrical parameters of the welding process, for example the arc voltage.

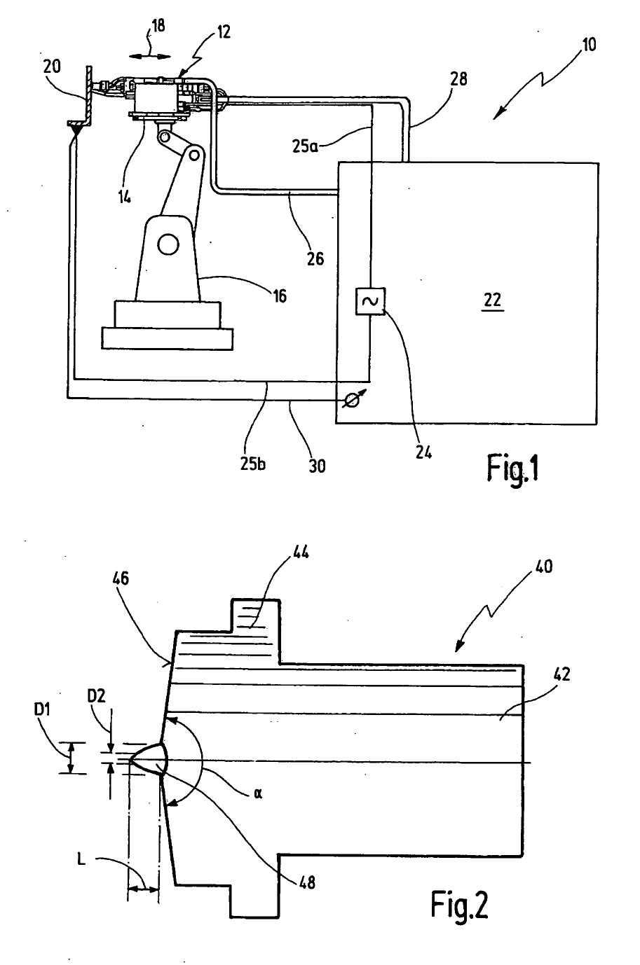

The stud welding system 10 operates in general according to the method of short-cycle arc welding with drawn-arc ignition. In the stud welding system 10, studs 40, such as are shown in FIG. 2, are welded to workpieces 20. The stud 40 shown in FIG. 2 is an aluminum stud (or a stud made of an aluminum alloy) and has in a manner that is conventional per se a cylindrical shank 42 and a circumferential flange 44.

The stud 40 is to be welded to the workpiece 20 at an end face 46. The end face 46 is conically tapered in general, with a cone angle α less than 180° and greater than 165° (see also guideline DVS0902). A conically tapering, distinct projection 48 is formed at the center of the end face 46. For a diameter of the shank 42 of approximately 8 mm, the projection 48 has a length L of approximately 0.6 mm. The diameter D1 of the projection 48 in the vicinity of the end face 46 is approximately 0.6 mm. The diameter D2 of the projection 48 in the vicinity of its free end is approximately 0.3 mm. In the stud 40 according to the invention, the projection 48 is designed to be rotationally symmetrical. The cross section of the projection 48 can also be polygonal, however, thus for example triangular, rectangular or even parabolic to conical.

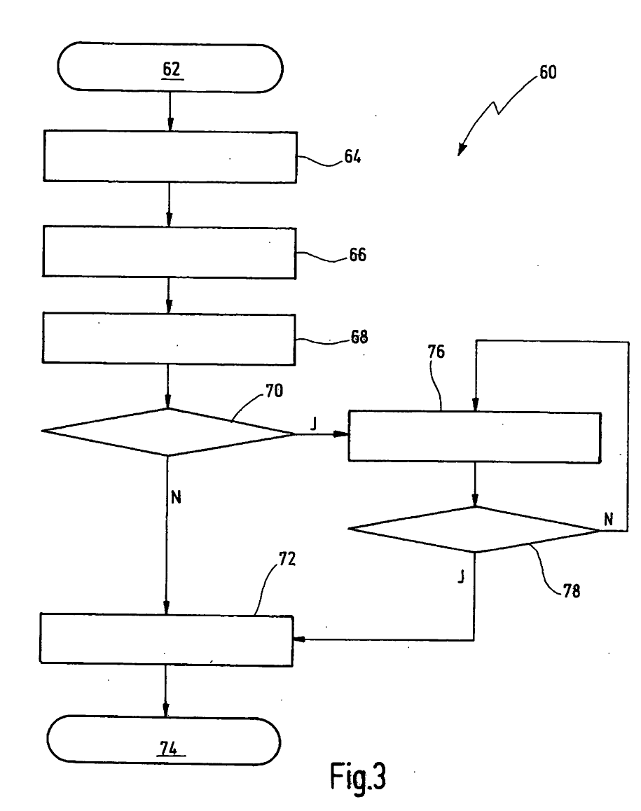

FIG. 3 represents a flow diagram of a preferred embodiment of the stud welding method according to the invention, which in FIG. 3 is labeled 60 overall. The stud welding method 60 has, following a start step 62, a first step 64 in which a stud 40 is supplied which has an end face 46 with which said stud is to be welded to a welding surface of the workpiece 20, wherein a distinct projection 48 is formed in the center of the end face 46. In this process, the stud 40 is accommodated, for example in a manner known per se, in a holder of a welding head 12. In addition, in the step 64 the robot 16 and the carriage 14 are moved such that the welding head 12 is positioned in a starting position in which its axis of travel 18 is approximately perpendicular to the workpiece 20.

In the next step 66, the projection 48 of the stud 40 is placed on the surface, i.e. on the welding surface of the workpiece 20, by the carriage 14 or by a stroke device (for example by a linear motor) provided in the welding head 12. In addition, an electric pilot current is then switched on in the step 66. In the next step 68, the stud 40 is lifted from the workpiece 20 (for example, by means of a linear motor), in which process an arc is drawn in accordance with the drawn arc method as a result of the electric pilot current that is flowing.

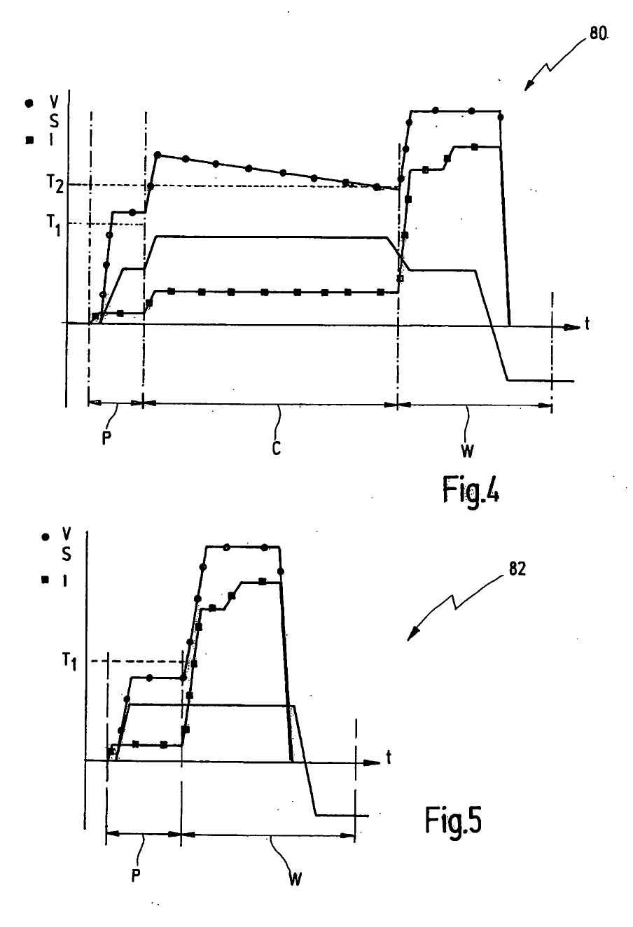

The steps 64, 66 and 68 are also shown in a diagram 80 in FIG. 4. FIG. 4 shows, as a function of time, the current I flowing between the stud 40 and the workpiece 20, the arc voltage V, and the travel S of the stud 40 relative to the workpiece 20. At the start of a pilot current phase P, the current I is raised to a pilot current value, after which the stud is initially lifted to a first level. In the representation of FIG. 4, an arc voltage V is established here which is greater than a first threshold value T₁.

In step 70 of FIG. 3, the arc voltage V is measured. If it is greater than the threshold value T₁ with the pilot current applied, a cleaning step 76 is performed. The cleaning step is labeled “C” (for clean flash method) in FIG. 4. If the arc voltage V exceeds the first threshold value T₁, this is an indication that the contamination on the end face 46 and/or the welding surface of the workpiece 20 is great enough that it is necessary for the cleaning step 76 to precede the actual welding step. In the cleaning step 76, the current I is raised to a cleaning current. In addition, the stud 46 is lifted further from the surface of the workpiece 20.

The arc drawn in the pilot phase P as a result of the pilot current is aligned concentric to the axis of the stud 40 on account of the distinct projection 48. The arc also remains concentric during the cleaning phase C, with the current during this cleaning phase C being sufficiently large that the distinct projection 48 is partly or completely melted. The surfaces of the components (i.e., the end face 46 and the welding surface of the workpiece 20) are not melted or are only slightly melted in this process, however. Instead, as a result of the cleaning current in phase C, the contaminants or coatings on the end face 46 and the welding face are removed, creating ideal conditions for the subsequent welding process. The arc always remains concentric to the axis in this process on account of the distinct projection.

During the cleaning phase C, the arc voltage V gradually decreases. In step 78 in FIG. 3, it is determined whether the arc voltage V has dropped below a second threshold value T₂. The second threshold value T₂ is in general greater than the first threshold value T₁.

If the arc voltage V has dropped below the second threshold value T₂ during the cleaning phase C (J [for Yes] in step 78 of FIG. 3), the cleaning phase C is terminated. Then the conventional welding step W is performed (step 72 in FIG. 3). In this process, the current I is first significantly increased to a welding current. This causes the end face 46 and the welding surface to start to melt. Alternatively, however, the cleaning current can be larger than the actual welding current, so that the current is lowered to a welding current. In advance, at the beginning of the welding phase W, the distance S between the stud 40 and the workpiece 20 is reduced again.

Next, the welding stud 40 is lowered during the welding phase W (W for welding) to the welding surface in such a manner that the flange section 44 of the stud 40 essentially rests on the surface of the workpiece 20. Consequently, the travel S of the stud in the representation in FIG. 4 also crosses the zero point (the stud sinks into the workpiece in a manner of speaking). The process is then ended (step 74).

A diagram 82 in FIG. 5 shows the case in which the arc voltage V with the pilot current I switched on is lower than the first threshold value T₁ during the pilot phase P. In this case (N in step 70 of FIG. 3), no cleaning phase is performed and the pilot phase P transitions directly to the welding phase W (step 72 in FIG. 3).

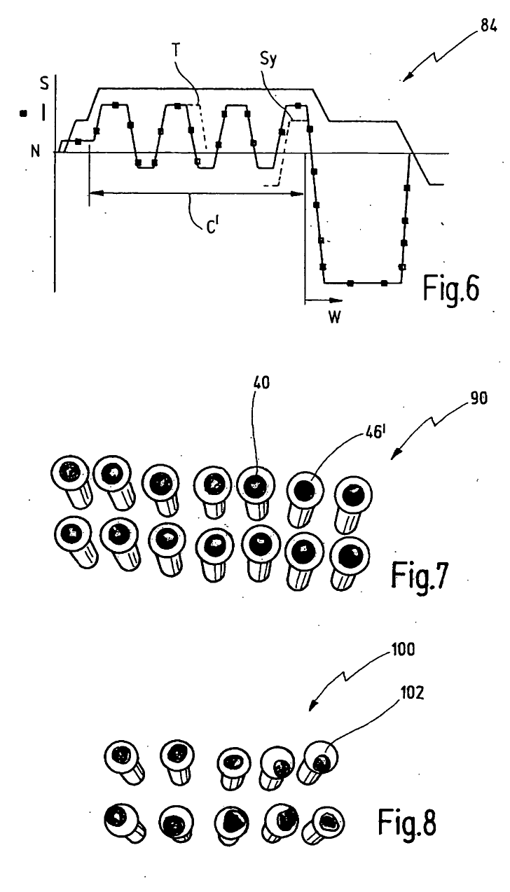

FIG. 6 shows an alternative embodiment of the welding method according to the invention in a diagram 84. In the variation of the welding method according to the invention, the cleaning current I is applied as an alternating current in a cleaning phase C′, wherein the polarity of the cleaning current I changes approximately four times during this phase. As is shown in diagram 84, the symmetry Sy with respect to the zero line N of the welding current I is displaced upward so that a significantly larger positive cleaning current than negative cleaning current is applied. This symmetry Sy is preferably adjustable, namely as a function of the boundary conditions predefined for a specific welding application.

Additionally (or as an alternative) hereto, the duty cycle T of the alternating current I during the cleaning phase C′ can also be adjusted as a function of these boundary conditions. It is a matter of course that an alternating current can be applied during the welding phase instead of a direct current insofar as this produces better welding results.

FIG. 7 shows a photograph 90 of a number of welding studs 40 for which a cleaning process C was performed prior to the actual welding process. It can be seen that the cleaning step C has led to a concentric cleaning effect. Despite a possibly uneven coating, all blow effects were suppressed here as a result of the fact that the studs 40 were provided with the distinct projection 48. Overall, this resulted in a more even formation of the circular cleaning zone concentric to the stud axis. Consequently, when there is appropriate concentric cleaning of the welding zone, optimal welding results can then be achieved.

FIG. 8 shows, in a representation 100 similar to FIG. 7, a number of end faces 102 of welding studs that were not provided with such a distinct projection. Here, as a result of the presumably domed surface, the arc has not always formed concentric to the stud axis. As a result, the cleaning results were not always concentric to the stud axis.

In cleaning the studs from photo 100, the following cleaning parameters were used:

5 milliseconds application of a negative current of 200 amps. Then 30 milliseconds application of a positive current of 200 amps, the entire process taking place at a distance of 3 mm between the end face and the welding surface.

The effect of such eccentric cleaning action on the quality of the subsequent welding procedures is obvious. In contrast, these disadvantages can be avoided completely when the method according to the invention and the studs 40 according to the invention are used. It is not necessary in this regard to provide means for magnetic arc deflection on the welding head 12 in order to make the arc symmetrical about the stud axis. Consequently, the forward end of the welding head 12 can be made slender with few interfering contours.

What is claimed is:

1. A method of manufacturing a stud welded onto a workpiece, the method comprising:
(a) making a metallic weld stud comprising a longitudinally elongated and substantially cylindrical shank, a laterally enlarged flange, a substantially smooth-conical end face, and a substantially conically tapering projection, substantially ending in a point, the projection being located at the center of the end face and connecting thereto as a single piece;
(b) feeding the weld stud to a welding head;
(c) moving the weld head toward the workpiece in order to contact the projection of the weld stud against the workpiece;
(d) creating an electric pilot arc;
(e) automatically retracting the weld head and weld stud away from the workpiece, during or after step (d);
(f) creating a welding arc;
(g) automatically advancing the weld head and weld stud toward the workpiece, during or after step (f);
(h) maintaining the welding arc substantially concentrically with an axis of the projection of the weld stud during welding; and
(i) welding the end face of the weld stud to the workpiece.

2. The method of claim 1, further comprising creating a cleaning arc temporally between the pilot arc and the welding arc, the arcs having different voltages.

3. The method of claim 1, further comprising placing a lubricant in the vicinity of the projection during manufacturing of the weld stud.

4. The method of claim 1, further comprising cold-forming the weld stud and making the end face transversely wider than the shank.

5. The method of claim 1, further comprising melting the projection of the weld stud during generation of a cleaning arc, the cleaning arc extending between the weld stud and the workpiece.

6. The method of claim 1, further comprising securing the workpiece to an automotive vehicle.

7. The method of claim 1, further comprising making the weld stud from aluminum or an aluminum alloy.

8. The method of claim 1, wherein the projection of the weld stud projects beyond the end face by 0.1 to 1 mm, inclusive.

9. The method of claim 1, wherein the projection of the weld stud projects beyond the end face by 0.3 to 0.6 mm, inclusive.

10. The method according to claim 1, wherein the projection of the weld stud has a diameter in the range from 0.1 to 2 mm, inclusive.

11. The method according to claim 1, wherein the projection of the weld stud has a diameter in the range from 0.3 to 1.2 mm, inclusive.

12. A method for short-cycle arc welding, with drawn-arc ignition, a stud to a workpiece, the method comprising:
(a) providing the stud comprising an end face with a distinct and localized projection located at the center of the end face;
(b) placing the projection of the stud adjacent the workpiece and switching on an electric pilot current;
(c) lifting the stud away from the workpiece to draw a pilot arc;
(d) flowing a welding current through the arc in such a manner that the end face and a portion of the workpiece start to melt after step (c), the currents being different;
(e) lowering the stud onto the workpiece, wherein the melts at the end face and workpiece mix; and
(f) switching off the welding current so that the entire melt solidifies to join the stud to the workpiece.

13. The method of claim 12, wherein after the lifting of the welding stud and before establishment of the welding current, a cleaning current is initially established in a cleaning step that is designed to clean contaminants from at least one of: the welding surface and the end face.

14. The method of claim 13, further comprising using an alternating current as the cleaning current.

15. The method of claim 14, further comprising setting a symmetry of the alternating current with respect to a zero line during the cleaning step as a function of the degree to which at least one of the end face and the portion of the workpiece is to be cleaned.

16. The method of claim 13, further comprising performing the cleaning step when the arc voltage at the pilot current has exceeded a first predetermined threshold value.

17. The method of claim 13, further comprising terminating the cleaning step when the arc voltage at the selected cleaning current drops below a second predetermined threshold value.

18. The method of claim 12, further comprising reversing the polarity of a cleaning current in the range from two to ten times during a cleaning step.

19. The method of claim 18, further comprising adjusting a duty cycle during the cleaning step as a function of the degree to which at least one of the end face and the portion of the workpiece is to be cleaned.

20. The method of claim 12, further comprising making the workpiece and the stud of an aluminum alloy.

21. The method of claim 12, further comprising:
(a) making the end face of the stud in a substantially smooth and conical shape; and
(b) making the projection of the stud with at least one tapered side surface substantially ending in a point, the projection being a single piece with the end face.

22. A method of welding a stud onto a workpiece, the method comprising:
(a) contacting the stud against the workpiece and creating a pilot current and arc between the stud and the workpiece as the stud is moved away from the workpiece;
(b) creating a cleaning current after the initial contacting of the stud against the workpiece;
(c) automatically varying the cleaning current based on a sensed contaminant characteristic on at least one welding surface; and
(d) creating a welding current through the arc, between the stud and the workpiece, after the cleaning current;
wherein the pilot, cleaning and welding currents are different.

23. The method of claim 22, further comprising performing a cleaning step when the arc voltage at the pilot current has exceeded a first predetermined threshold value.

24. The method of claim 23, further comprising terminating the cleaning step when the arc voltage at the selected cleaning current drops below a second predetermined threshold value.

25. The method of claim 22, further comprising using an alternating current as the cleaning current.

26. The method of claim 25, further comprising setting a symmetry of the alternating current with respect to a zero line during the cleaning step as a function of the degree to which at least one of the end face and the portion of the workpiece is to be cleaned.

27. The method of claim 22, further comprising melting a conically tapered and substantially pointed projection of the stud during operation of the cleaning arc.

28. The method of claim 27, further comprising maintaining the welding arc substantially concentrically with an axis of this projection.

29. The method of claim 22, further comprising reversing the polarity of the cleaning current in the range from two to ten times during a cleaning step.

30. The method of claim 22, further comprising adjusting a duty cycle during the cleaning step as a function of the degree to which at least one of the stud workpiece is to be cleaned.

31. The method of claim 22, further comprising automatically varying the cleaning current based on a sensed insulating value of the contaminant.

32. The method of claim 22, further comprising automatically bypassing the cleaning current if the contaminant characteristic is automatically determined to fall within an acceptable range.

33. A method of manufacturing a weld stud, the method comprising:
(a) making a longitudinally elongated and substantially cylindrical shank;
(b) making a laterally enlarged flange;
(c) making a substantially smooth-conical end face; and
(d) making a substantially conically tapering projection substantially converging to a point, wherein the projection, end face, flange and shank are made as a single piece.

34. The method of claim 33, further comprising placing a lubricant in the vicinity of the projection during manufacturing of the weld stud.

35. The method of claim 33, further comprising cold-forming the weld stud and making the end face transversely wider than the shank.

36. The method of claim 33, further comprising making the weld stud from aluminum or an aluminum alloy.

37. The method of claim 33, wherein the projection of the weld stud projects beyond the end face by 0.1 to 1 mm, inclusive.

38. The method of claim 33, wherein the projection of the weld stud projects beyond the end face by 0.3 to 0.6 mm, inclusive.

39. The method according to claim 33, wherein the projection of the weld stud has a diameter in the range from 0.1 to 2 mm, inclusive.

40. The method according to claim 33, wherein the projection of the weld stud has a diameter in the range from 0.3 to 1.2 mm, inclusive.
